(19) United States
(12) Patent Application Publication
(10) Pub. No.: US 2025/0360840 A1
(43) Pub. Date: Nov. 27, 2025

(54) METHOD FOR OPERATING A FUEL CELL SYSTEM OF A MOTOR VEHICLE, IN PARTICULAR OF A COMMERCIAL VEHICLE, AND A MOTOR VEHICLE

(71) Applicant: DAIMLER TRUCK AG, Leinfelden-Echterdingen (DE)

(72) Inventors: Ottmar GEHRING, Sindelfingen (DE); Steffen MAUS, Reutlingen (DE); Jens FRANZEN, Stuttgart (DE)

(21) Appl. No.: 18/873,777

(22) PCT Filed: May 9, 2023
(86) PCT No.: PCT/EP2023/062310

§ 371 Date: Dec. 11, 2024

(30) Foreign Application Priority Data
Jun. 13, 2022 (DE) 10 2022 114 781.9

(51) Int. Cl. B60L 58/33; H01M 8/04007; H01M 8/04082; H01M 8/0438; H01M 8/04537; H01M 8/04992

(52) U.S. Cl. CPC B60L 58/33; H01M 8/04059; H01M 8/04201; H01M 8/0438; H01M 8/04626; H01M 8/04992; H01M 2250/20

(57) ABSTRACT

A method for operating a fuel cell system of a motor vehicle, the fuel cell system having a hydrogen tank, a one fuel cell, and a cooling device for cooling at least one part of the fuel cell system. Energy consumption of the cooling device is predicted depending on a planned driving route of the motor vehicle, a future temporal pressure curve of a pressure prevailing in the hydrogen tank is predicted and a future temporal energy curve of an amount of heat energy to be supplied according to the energy curve from the cooling device to the hydrogen tank depending on the predicted energy consumption is predicted, in order to realize the pressure curve.

### BACKGROUND AND SUMMARY OF THE INVENTION

Exemplary embodiments of the invention relate to a method for operating a fuel cell system of a motor vehicle, in particular of a commercial vehicle, as well as to a motor vehicle, in particular a commercial vehicle.

A method for predictive operation of a motor vehicle having a fuel cell system is known from WO 2016/083365 A1.

Exemplary embodiments of the present invention are directed to a method for operating a fuel cell system of a motor vehicle and a motor vehicle, so that a particularly efficient operation can be realized.

A first aspect of the invention relates to a method for operating a fuel cell system of a motor vehicle, preferably in the form of a commercial vehicle, in particular as a heavy goods vehicle, and also simply referred to as a vehicle. The fuel cell system has at least one hydrogen tank, which is also simply referred to as tank. Hydrogen (H₂) can be or is received in the hydrogen tank. The fuel cell system, also referred to as a fuel cell device or fuel cell apparatus, further comprises at least one fuel cell that can be supplied with hydrogen from the hydrogen tank. As is well known, chemical reaction energy of hydrogen, which is supplied to the fuel cell, and an oxidant can be converted by means of the fuel cell into electrical energy, which can be supplied by the fuel cell. In particular, oxygen is used as the oxidant, which is contained in the air for example, which can be or is likewise supplied to the fuel cell. The electric energy, which can be or is supplied by the fuel cell, can be at least temporarily stored in an electric energy storage device, designed in particular as a battery, specifically as a secondary battery. Furthermore, it is conceivable that at least one electric engine can be or is supplied with the electric energy, that can be or is supplied by the fuel cell, in particular directly and thus bypassing the electrical energy storage device, wherein alternatively or additionally it is conceivable that the electric engine can be supplied with the electrical energy, which is stored in the electrical energy storage device. By supplying electrical energy to the electric engine, the electric engine can be operated in a motor mode and thus as an electric motor, by means of which the motor vehicle can be driven electrically, in particular purely electrically.

The fuel cell system also has a cooling device, by means of which at least one part of the fuel cell system can be cooled. In particular, at least a partial region of the cooling device can be flowed through by a liquid coolant, for example, by means of which at least a part of the fuel cell system can be cooled. The cooling device is also referred to as a cooling system.

In order to be able to realize a particularly efficient, in particular energy-efficient, operation of the fuel cell system and thus of the motor vehicle, it is provided in the method according to the invention that energy consumption of the cooling device is predicted, i.e., forecast, i.e., predictively determined, in particular by means of an electronic computing device, in particular of the motor vehicle, depending on a planned driving route of the motor vehicle. This is understood in particular to mean that the energy consumption is determined, in particular calculated, at a first time point, or during a first time period, wherein the first time point or the first time period temporally precedes a second time period, during which the motor vehicle drives on or sets off on the planned driving route, i.e., actually drives along the driving route. In other words, the energy consumption is determined before the motor vehicle is driving along the driving route or the motor vehicle has not (yet) driven along the driving route. The driving route can comprise at least one or more refueling operations, also simply referred to as refueling. Because the driving route is a planned driving route, the refueling operation is in particular a planned refueling process that may take place in the future, if necessary, during which hydrogen is filled into the tank, in particular from outside the tank, and therefore the tank is at least partially filled with hydrogen. For example, the refueling operation is required or estimated or determined as necessary, so that the motor vehicle can drive along, in particular, the entire driving route. Furthermore, it is conceivable that the planned driving route comprises at least one or more standstill times. In particular because the driving route is a planned driving route, the standstill time is a planned standstill time during which the motor vehicle, for example, stands still, in particular continuously, and/or the motor vehicle is not driven by the fuel cell system, in particular continuously, and/or the fuel cell system is not operated, in particular continuously. In particular, discharging hydrogen from the hydrogen tank and/or providing electrical energy through the fuel cell can be omitted during the standstill time. In particular, the predicted energy consumption is a temporal energy consumption, thus a temporal energy consumption curve of an energy consumption of the cooling device, wherein the energy consumption or the energy consumption curve is a determined, calculated or estimated and thereby predicted energy consumption curve which characterizes an energy or amount of energy which is likely to be consumed by the cooling system when or while the motor vehicle is travelling along the driving route, i.e., is being driven.

In the method, a future temporal pressure curve of a pressure prevailing in the hydrogen tank and which is caused or can be caused in particular by the hydrogen that is received or can be received in the hydrogen tank is also predicted, that is to say determined or predicted in advance, in particular depending on the driving route. The future temporal pressure curve is thus, for example, a planned, in particular specified or specifiable temporal pressure curve, wherein, for example, the pressure curve is a target curve, which is to be set, i.e., is to be caused.

In the method according to the invention, a future temporal energy curve of an amount of heat energy which is to be supplied, i.e., is intended to be supplied, according to the energy curve from the cooling device to the hydrogen tank depending on the predicted energy consumption is also predicted, in order to realize the pressure curve. In other words, the energy curve specifies a temporal curve, according to which the mentioned amount of heat energy is or is to be provided by the cooling device, taking into consideration the predicted energy consumption of the cooling device, and is or is to be supplied to the hydrogen tank, in particular while the motor vehicle set off or drives along the driving route, in order to thereby realize the pressure curve. As a result, the cooling device can provide thermal energy in at least one or more partial sections of the driving route, which is supplied to the hydrogen tank so that the hydrogen tank is used as a heat buffer or heat sink. Therefore, an excessively high thermal load, i.e., an excessively high temperature of the cooling device, can be avoided, without the cooling device having to be cooled by means of a fan, in particular electrical fan, for example. Thus, the method is a method for predictive heat or thermal regulation of the fuel cell system.

The invention is thus based in particular on the following findings and considerations: Typically, a powerful cooling system is used in a motor vehicle equipped with a fuel cell and thus also referred to as a fuel cell vehicle, which cooling system can discharge power dissipation from the fuel cell, especially during high-load phases of the fuel cell, in particular from the fuel cell, and ensure that a relatively narrow temperature operating window of the fuel cell is maintained, i.e., that the fuel cell or a temperature of the fuel cell remains within the temperature operating window. Thus, the cooling device is used, in particular, in order to cool the fuel cell and thus to maintain the temperature operating window. For example, the temperature operating window is at least essentially ±8 to 10° C. In addition, in a fuel cell vehicle designed as a heavy-duty commercial vehicle, for example, the cooling system may also be subjected to additional heat input from activated sustained-action brakes, designed for example as retarders, brake resistors, etc., in particular because the cooling system is also used, for example, to cool a sustained-action brake, designed as a retarder or brake resistor, of the vehicle. Conventionally, the cooling system (cooling device) therefore cools a retarder and the vehicle's fuel cell at the same time, at least during one time interval. In high-load phases of the fuel cell system, this can lead to long activation periods, i.e., long periods of time in which an electrically driven fan is operated that requires or has a power of up to 30 or 40 kW, for example. By means of the fan, which can be a component of the cooling device or of the cooling system, the aforementioned coolant is cooled for example, in particular via a heat exchanger, in particular by the fan, when it is activated, conveying air which flows around the heat exchanger designed, for example, as an air-coolant heat exchanger. The heat exchanger transfers heat from the coolant to the air flowing around the heat exchanger and conveyed by the fan. Furthermore, in order to heat up the cryogenic liquid hydrogen, for example, a particularly permanent heat flow may be required, which can be diverted from a heat supply from heat sources if the cooling system (cooling device) is designed accordingly. The fuel cell and the retarder, for example, can be used as heat sources the heat of which, also known as waste heat, can be utilized to heat the hydrogen that is or can be received in the hydrogen tank in the tank and/or the hydrogen discharged from the hydrogen tank on its way to the fuel cell. The hydrogen that can be received or is received in particular in the hydrogen tank or the hydrogen tank can thus be used as a heat sink, for example in order to relieve the cooling system (cooling device) by buffering heat, in particular waste heat, in the hydrogen tank during high-load phases with high energy consumption of the cooling device, for example by operating the aforementioned fan, and thus save energy. In other words, the method according to the invention makes it possible in a particularly efficient and effective manner to discharge heat, in particular waste heat, from the cooling device, in particular from the coolant, but not or not only by operating the aforementioned fan, but in particular due to the fact that the amount of heat energy is discharged from the cooling device, in particular from the coolant, according to the energy curve and is supplied to the hydrogen tank, in particular to the hydrogen received in the hydrogen tank.

The amount of heat energy is or thus characterizes a heat energy or heat that is discharged from the cooling device, in particular from the cooling medium, whereby an excessive temperature of the cooling device can be avoided without having to operate the fan. In order to discharge the amount of heat energy (heat) from the cooling device, the amount of heat energy is supplied to the hydrogen tank, which is thus used at least temporarily as a heat buffer or heat sink. If, in particular, more heat is fed into the hydrogen tank, i.e., in particular more heat is supplied to the hydrogen tank, the pressure in the hydrogen tank rises due to increasing vaporization of the hydrogen in the hydrogen tank. The pressure in the hydrogen tank should not rise above a limit, in particular a limit that can be or is predetermined, in particular the load limit of the tank, and the pressure in the hydrogen tank, also referred to as the tank pressure, should be lowered before a refueling process, also referred to as a tank process, and/or a particularly long stationary phase or standstill time of the motor vehicle. The method according to the invention can now ensure energy savings by selectively setting, in particular increasing, the tank pressure on the one hand and, in particular, matching pressure ratios before refueling processes and/or standstill times on the other hand, so that a particularly advantageous and, in particular, efficient operation of the fuel cell system and of the motor vehicle as a whole can be realized. The pressure curve and the energy curve are also referred to as trajectories, in particular in such a way that the pressure curve is also referred to as the pressure trajectory and the energy curve is also referred to as the heat energy trajectory. The heat energy amount is, for example, a target heat energy amount to be supplied to the hydrogen tank, i.e., to be supplied in order to realize the pressure trajectory, i.e., to cause it. In this way, the pressure trajectory and the associated heat energy trajectory are predictively determined in the method. Furthermore, the energy consumption of the cooling device is predictively determined, in particular calculated, in order to determine at least one or more time intervals, i.e., phases, in which an energy discharge, in particular of the cooling device, into the hydrogen tank can or should take place. Energy discharge is understood to mean that, in particular during the respective phase, the amount of heat energy and thus heat is or can be provided by the cooling device and supplied to the hydrogen tank in order to thereby set the predicted pressure curve, i.e., to cause it. The invention can thus reduce the energy consumption of the fuel cell system, in particular with regard to thermal management, compared to conventional solutions, whereby the energy consumption of the entire motor vehicle can be reduced compared to conventional solutions. Therefore, the motor vehicle can be operated in a particular energy-effective and cost-effective manner. In addition, an overloading of the cooling device with associated shut-off of components such as a drive of the motor vehicle can at least be delayed or avoided.

In order to be able to realize a particularly efficient operation of the fuel cell system and thus of the motor vehicle as a whole, it is provided in an advantageous embodiment of the invention that the pressure curve and the energy curve, and thus the trajectories, are predicted in such a way that in first operating phases of the cooling device, the predicted energy consumption is greater in the first operating phases than in second operating phases of the cooling device, greater thermal energy is supplied from the cooling device to the hydrogen tank than in the second operating phases. As a result, the hydrogen tank can be used effectively and efficiently as a heat buffer, at least temporarily, whereby excessive temperatures of the cooling device can be avoided without having to actively cool the cooling device, for example by the so-called fan. This means in particular that, for example, the temporal integral of the energy curve in the respective first operating phase is greater than the second integral of the energy curve in the respective second operating phase. In other words, a first part of the amount of heat energy is greater than a second part of the amount of heat energy, the first part being supplied to the hydrogen tank by the cooling device in the respective first operating phase and the second part being supplied to the hydrogen tank in the respective second operating phase. In particular, the first part is greater than zero, in which case the second part can be greater than zero or equal to zero.

It has been shown to be particularly advantageous if, in at least one of the second operating phases, a transfer of thermal energy from the cooling device to the hydrogen tank does not occur. On the one hand, this can effectively and efficiently prevent excessive temperatures in the cooling device. On the other hand, an excessive increase in pressure in the hydrogen tank can be avoided thereby.

A further embodiment is characterized by the fact that the pressure curve is predicted in such a way that the pressure is always, i.e., continuously, less than or equal to a maximum pressure, in particular a maximum pressure that is or can be predetermined, over its entire pressure curve. As a result, thermal energy can be effectively and efficiently transferred from the cooling device to the hydrogen tank, while at the same time excessive loads or damage to the hydrogen tank can be safely avoided.

In order to be able to use the hydrogen tank particularly effectively and efficiently as a heat buffer, it is provided in a further embodiment of the invention that at least the pressure curve is predicted depending on at least one refueling process intended for filling the hydrogen tank and/or depending on at least one standstill time of the vehicle, which is stationary during the standstill time and is not driven by means of the fuel cell system, in particular is not travelling. In particular, the refueling process and/or the standstill time are part of the planned driving route.

A second aspect of the invention relates to a motor vehicle, in the form preferably of a commercial vehicle, in particular a heavy goods vehicle, which is also simply referred to as a vehicle and is designed to carry out a method according to the first aspect of the invention.

For example, the pressure trajectory and the heat energy trajectory, i.e., the pressure curve and the energy curve, are determined, i.e., predicted, in such a way that in high-load phases with increased energy consumption of the cooling device, more heat is discharged from the cooling device into the hydrogen tank, i.e., supplied to the hydrogen tank, wherein preferably the maximum pressure, which is or characterizes a maximum pressure limit, is maintained, i.e., the tank pressure is always less than or equal to the maximum pressure.

For example, the pressure trajectory and the heat energy trajectory are determined, in particular predicted, in such a way that in partial and/or low-load phases, in particular of the cooling device, where, for example, in the respective partial and/or low-load phase the cooling device has a lower energy consumption than in the respective high-load phase, a heat supply from the cooling device to the hydrogen tank, and thus the supply of the heat energy amount from the cooling device to or into the hydrogen tank, is reduced, in particular compared to the respective high-load phase, i.e., throttled or completely stopped, i.e., prevented, in order to enable a pressure reduction in the hydrogen tank, i.e., a reduction in the pressure in the hydrogen tank, in particular in comparison to the respective high-load phase, in particular as a result of hydrogen consumption taking place during the partial and/or low load phase, during which hydrogen is removed from the hydrogen tank and supplied to the fuel cell, for example. For example, a hydrogen consumption along the driving route and the pressure curve of the pressure in the hydrogen tank, also known as the pressure development, are also known through the planning, i.e., a predictive determination, in particular calculation, of the driving route, also known as the tour, and can therefore be implemented in a predictively planned manner. In other words, the planned driving route includes, for example, a predictive consumption of the hydrogen from the hydrogen tank, in particular by the fuel cell system and/or at least one other, further consumption.

If, for example, no refueling process is planned or known, a possible refueling process can be assumed when an amount of hydrogen in the hydrogen tank, also referred to as the fill level, falls below a threshold, in particular a threshold that is or can be predetermined, and the function described above for buffering waste heat from the cooling device in the hydrogen tank can be throttled, i.e., scaled back or reduced or completely prevented, i.e., deactivated.

Further advantages, features and details of the invention can be seen from the following description of a preferred exemplary embodiment and with reference to the drawing. The features and combinations of features mentioned above in the description as well as the features and combinations of features mentioned below in the description of the figures and/or shown alone in the figures can be used not only in the combination indicated in each case, but also in other combinations or on their own, without leaving the scope of the invention.

Further advantages, features and details of the invention can be seen from the following description of a preferred exemplary embodiment and with reference to the drawing. The features and combinations of features mentioned above in the description as well as the features and combinations of features mentioned below in the description of the figures and/or shown alone in the figures can be used not only in the combination indicated in each case, but also in other combinations or on their own, without leaving the scope of the invention.

### BRIEF DESCRIPTION OF THE DRAWING FIGURES

The drawing shows in:

FIG. 1 a schematic representation of a fuel cell system of a motor vehicle preferably in the form of a commercial vehicle, in particular a heavy goods vehicle;

FIG. 2 a flow diagram to illustrate a method for operating the fuel cell system of the motor vehicle shown schematically in FIG. 2; and

FIG. 3 part of a schematic sectional view of a tank system of the fuel cell system, comprising a hydrogen tank.

In the figures, identical or functionally identical elements are provided with the same reference signs.

### DETAILED DESCRIPTION

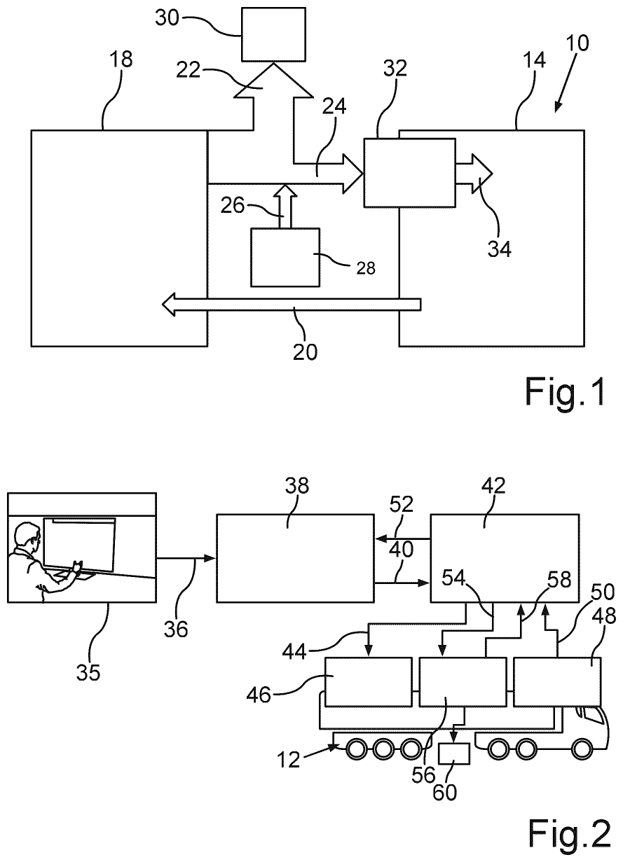

In a schematic representation, FIG. 1 shows a fuel cell system 10 of a motor vehicle 12 shown schematically in FIG. 2, which is in the form of a commercial vehicle, in particular a heavy goods vehicle. In the following, a method for operating the fuel cell system 10 is described using FIGS. 1 to 3, wherein a particularly efficient, in particular energy-efficient operation of the fuel cell system 10 and thus of the motor vehicle 12 overall can be realized by the method.

It can be seen from FIG. 1 that the fuel cell system 10 has at least one hydrogen tank 14, represented particularly schematically in FIG. 1 and also simply referred to as a tank, in which hydrogen can be or is received. In combination with FIG. 3, it can be seen that the hydrogen tank 14 is a component of a tank system 16, also referred to as a tank device, which is explained in more detail in the following. The hydrogen is received pressurized in the hydrogen tank 14, so that a pressure caused by the hydrogen received in the hydrogen tank 14, also referred to as tank pressure, is present in the hydrogen tank 14, which, for example, is and in particular should be in a range from 6 bar to 15 bar inclusive. In particular, a liquid phase and a gaseous phase of the hydrogen are contained in the hydrogen tank 14. The fuel cell system 10 also comprises at least one fuel cell 18, which can be supplied with the hydrogen from the hydrogen tank 14, as is illustrated in FIG. 1 by an arrow 20. To this end, the hydrogen is discharged from the hydrogen tank 14 and, in particular in a gaseous state, is supplied to the fuel cell 18. The fuel cell 18 can be understood to be a fuel cell stack, for example, or the fuel cell 18 is a component of a fuel cell stack, which can have several fuel cells 18.

Waste heat, also simply referred to as heat, is illustrated by arrows 22 and 24 and is discharged or supplied from the fuel cell 18, for example during its operation. Waste heat, also simply referred to as heat, is also illustrated by an arrow 26 and can be discharged, i.e., supplied, from at least one sustained-action brake 28 of the motor vehicle 12, in particular during operation of the sustained-action brake 28. The motor vehicle 12 can be braked by means of the sustained-action brake designed as a retarder, for example, in particular in such a way that a speed at which the motor vehicle 12 is driven along a road is not increased or decreased. For example, the waste heat of the fuel cell 18 and the waste heat of the sustained-action brake 28 constitutes a total waste heat. For example, it is illustrated by the arrow 22 that a first part of the total waste heat is discharged to a cooling device 30 of the fuel cell system 10, represented particularly schematically in FIG. 1 and also referred to as a cooling system, in particular in such a way that the first part of the total heat, for example, is transmitted to an in particular liquid coolant of the cooling device 30, for example via a heat exchanger. Thus, the fuel cell 18 and preferably also the sustained-action brake 28 is cooled by means of the cooling device 30.

It is illustrated by the arrow 24 that a second part of the total waste heat can be transmitted to or onto the hydrogen tank 14 and thus to or onto the hydrogen received in the hydrogen tank 14, in particular via a heating device 32 of the fuel cell system 10, represented particularly schematically in FIG. 1 and also simply referred to as a heater, so that the second part of the total waste heat can be kept away from the cooling device 30, i.e., it is not discharged by the cooling device 30. As a result, an in particular thermal load of the cooling device 30 can be kept advantageously low. The cooling device 30 has a refrigeration circuit through which the coolant can flow. For example, the cooling device 30 comprises a fan, in particular that can be operated electrically, by means of which air can be conveyed. The air can flow around a radiator, for example, which the coolant can flow through. Consequently, heat transfer from the coolant via the radiator to the air flowing around the radiator and conveyed by means of the fan can cool the coolant. Since, as illustrated by the arrows 22 and 24, not all of the waste heat is discharged to and through the cooling device 30, but the second part of the total waste heat is transferred to or onto the hydrogen tank 14 and thus buffered, for example, by means of the hydrogen tank 14, an excessively long operating time of the fan taking place during a total time period can be kept advantageously low, for example, so that a particularly efficient, in particular energy-efficient, operation of the cooling device 30 and thus of the fuel cell system 10 as a whole can be realized.

By transferring the heat, i.e., the second part of the total waste heat, to the hydrogen tank 14, as illustrated in FIG. 1 by an arrow 34, vaporization of liquid hydrogen contained in the hydrogen tank 14, i.e., of at least part of the liquid phase of the hydrogen in the hydrogen tank 14, is brought about, as a result of which the tank pressure increases. As is explained again in more detail in the following, the hydrogen tank 14, in particular the tank system 16 is used in order to relieve the load on the cooling device 30 by buffering waste heat, i.e., the second part of the total waste heat in the hydrogen tank 14, in high-load phases with high energy consumption of the cooling device 30, whereby energy, in particular electrical energy can be saved. For this, as is explained in more detail in the following, an energy consumption of the cooling device 30 is predicted depending on a planned and for example predicted driving route of the motor vehicle 12. Furthermore, a future temporal pressure curve of the pressure prevailing in the hydrogen tank 14, i.e., the tank pressure, is predicted. For example, the energy consumption and the pressure curve, which is also referred to as a pressure trajectory, is predicted, i.e. predictively determined by means of an electronic computing device, in particular of the motor vehicle 12.

Furthermore, in particular by means of the electronic computing device, a future, temporal energy curve, also referred to as an energy trajectory or heat energy trajectory, of an amount of heat energy which is to be supplied, i.e., is intended to be or should be supplied, according to the energy curve by the cooling device 30 and thus, for example, via the cooling device 30 to the hydrogen tank 14 depending on the predicted energy consumption is predicted, in order to realize the pressure curve. The amount of heat energy is thus heat, i.e., thermal energy or an amount of thermal energy, which is illustrated, for example, in FIG. 1 by the arrow 24. In other words, the arrow 24 illustrates, for example, the amount of heat energy that is the second part of the total waste heat and that is to be supplied or is supplied according to the predicted energy curve by the cooling device 30, for example via the coolant or by means of the coolant, to the hydrogen tank 14 depending on the predicted energy consumption, in order thereby to realize the pressure curve, in particular while the motor vehicle 12 is driving along the planned driving route, in particular while it is actually driving.

In FIG. 2, a planning module, also referred to as logistics planning or designed for carrying out logistics planning, is shown particularly schematically and referenced with 34. For example, the driving route, which is also referred to as a tour, is planned by means of the planning module 34, i.e., predictively planned. For example, the planning module 34 is used to determine, in particular schedule, when, i.e., at what time or during what time period, the motor vehicle 12 drives on which driving route, also referred to as a stretch, where, i.e., at what point along the driving route, refueling is carried out, i.e., a refueling process is carried out, when, i.e., at what time the journey of the motor vehicle 12 along the driving route is interrupted or where standstill times are planned, i.e., take place. The fueling process, which is also referred to as a tank process, is a process by on in which hydrogen is filled into the hydrogen tank 14, in particular from outside the hydrogen tank 14, in particular from outside the motor vehicle 12 as a whole. The respective standstill time is a time period or a time interval, during which the motor vehicle 12 stands still and thus is not driven by means of the fuel cell system 10, so that for example during the respective standstill time, discharge of hydrogen from the hydrogen tank 14, in particular to the fuel cell 18 is omitted. Other parameters, which characterize the driving route or the motor vehicle 12 along the driving route, are taken into consideration when planning the driving route. The parameters may include, for example, a load of the motor vehicle 12 and/or a planned operation of each consumption of a motor vehicle 12, wherein it may be for example, a refrigerated body, for example, for cooling a cargo space of the motor vehicle 12.

It is illustrated by an arrow 36 that relevant, in particular all relevant, tour planning data, which characterizes the planned driving route, is transmitted to an operating strategy module 38 and received by the operating strategy module 38. The operating strategy module 38 determines, in particular calculates, for example, an operating strategy, in particular the whole operating strategy for the planned driving route, also referred to as a tour. For example, the operating strategy is a predictively determined, i.e., planned operating strategy, according to which the fuel cell system 10 is or is to be operated, in particular when the motor vehicle 12 is actually driving along the driving route. This includes, for example, a torque to be provided by a drive device in order to drive the motor vehicle 12 and thus to travel along the driving route, also referred to as the driving stretch, so that the motor vehicle 12 can complete the driving route, a target trajectory derived therefrom for a power of the fuel cell 18, also referred to as fuel cell power, and in particular a state of charge curve of a buffer battery of the motor vehicle 12 associated therewith. The drive device comprises, for example, at least one electric engine, by means of which the motor vehicle 12 can be driven electrically, in particular purely electrically, in order therefore to drive the motor vehicle 12 along the driving route. The buffer battery is a battery, in particular a secondary battery, in which, for example, electric energy, which is or can be supplied by the fuel cell 18, is at least temporarily stored, i.e., can be buffered. For example, the drive device, in particular the electric engine, can be supplied with the electric energy supplied by the fuel cell 18 and/or with the electric energy stored in the battery, so that the motor vehicle 12 can be electrically driven by means of the electric engine. The operating strategy takes into consideration, for example, at least one or more sustained-action brake systems of the motor vehicle 12, like the sustained-action brake 28, for example. In other words, the operating strategy also comprises, for example, a strategy for operating the sustained-action brake 28 along the driving route, wherein the sustained-action brake 28, as described above, creates or can create additional heat input, in particular into the cooling device 30.

Furthermore, the pressure curve and the energy curve are predicted. The amount of heat energy is a target amount of heat energy, which is to be supplied to the hydrogen tank 14, in particular when the motor vehicle 12 drives the driving route, in order to cause the pressure curve, i.e., to realize it. By predicting the energy consumption of the cooling device 30, operating phases as referred to simply as phases can be determined, during which, while the motor vehicle 12 is travelling along the driving route, energy can be discharged in the hydrogen tank 14, and thus the amount of heat energy can be supplied to the hydrogen tank 14. In particular, standstill times can be forecast, i.e., predicted, if necessary, if driving times, journey times and habits relating to normal operating and standstill times are analyzed.

The determined, in particular calculated, operating strategy is transmitted, as illustrated by an arrow 40, in particular by the operating strategy module 38, to a thermal management module 42 and received by the thermal management module 42. For example, the operating strategy module 38 and/or the thermal management module 42 is part of the aforementioned electronic computing device.

The pressure trajectory and the heat energy trajectory are also simply referred to as trajectories and are target trajectories. The thermal management module 42 is designed to implement, i.e., realize, the previously strategically determined, in particular calculated, target trajectories, i.e., to operate, in particular control or regulate, the fuel cell system 10 in such a way that the target trajectories are implemented, i.e., that the fuel cell system 10 works or is operated in accordance with the predicted target trajectories. This is achieved, for example, by the thermal management module 42, as illustrated by an arrow 44, controlling an actuator 46, also known as an actuator system or thermal system actuator, in particular of the fuel cell system 10. The actuator 46 comprises, for example, valves, pumps, and at least one or more fans, such as the aforementioned fan. For example, a sensor 48 is also provided, which is also referred to as a thermal system sensor. As is illustrated by an arrow 50, the sensor 48 can detect measured variables, such as for example pressures and/or temperatures of the fuel cell system 10, and transmit them to the thermal management module 42, which can activate, i.e., operate, in particular control or regulate the fuel cell system 10, in particular the actuator 46, depending on the measured variables detected by means of the sensor 48, in particular in order to thereby implement the target trajectories, i.e., to operate the fuel cell system 10 according to the target trajectories.

One of the measured variables is, for example, the aforementioned tank pressure. One of the other measured variables is, for example, other pressures of the fuel cell system 10. Furthermore, the measured variables can comprise at least one or more temperatures of the fuel cell system 10. The respective pressure is detected, for example, by means of a respective pressure sensor. The respective temperature is detected, for example, by means of a respective temperature sensor. For example, regulating the fuel cell system 10, in particular the actuator 46, is carried out at specified or specifiable target values by means of the thermal management module 42, in particular in such a way that the target trajectories are actually implemented. If a predictively calculated target requirement, such as the tank pressure and/or a temperature of the coolant, is not achieved or cannot be achieved, as illustrated by an arrow 52, the predictive operating strategy can be redetermined, in particular recalculated, in particular by the operating strategy module 38, in particular based on new status data, which is detected, for example, by the sensor 48 and thus determined by the thermal management module 42 and, in particular, transmitted to and received by the operating strategy module 38, as illustrated by the arrow 52. This can be performed cyclically for example, in particular in each case based on current states and measured values of the motor vehicle 12. For example, the coolant comprises at least water so that the coolant is also referred to as cooling water, for example.

As illustrated, for example, by an arrow 54, the thermal management module 42 can transmit to an operating module 56 for operating, in particular for regulating or controlling, the tank system 16 at least one or more requirements for heating the hydrogen tank 14, i.e., for supplying the amount of heat energy to the hydrogen tank 14 according to the energy curve and thus warming it up, i.e., heating it. For example, the operating module 56 is a component of the electronic computing device. The operating module 56 is referred to as a tank control module or tank regulating module, for example. For example, as is illustrated by the arrow 54, a need for heat discharge from the hydrogen tank 14, in particular at a desired time point or during a desired time period, is transmitted from the thermal management module 42 to the operating module 56, and in particular is received by the operating module 56. The operating module 56 implements the requirements supplied by the thermal management module 42 and received by the operating module 56, in particular in the context of possibilities and/or in the context of the permitted pressure range which corresponds, for example, to the aforementioned range of from 6 to 15 bar, and reports back this implementation to the thermal management module 42, as is illustrated by an arrow 58. The report comprises, for example, an estimated amount of heat discharged from or by the hydrogen tank 14 based on the requirement, as well as the tank pressure, in particular as an actual pressure, which prevails in the hydrogen tank 14 and is caused in particular by the hydrogen received in the hydrogen tank 14. A central, i.e., effective control or regulating element for regulating, i.e., for adjusting a heat flow in the hydrogen tank 14, i.e., to adjust the amount of heat energy which is supplied to the hydrogen tank 14, is for example a valve 60, represented particularly schematically in FIG. 2 and, for example, designed as a pressure valve, in particular as a pressure control valve or pressure regulation valve, which, for example, can be activated by the operating module 56 and therefore operated, in particular regulated or controlled. For example, a flow or current of the in particular gaseous hydrogen through a heat exchanger 62 shown in FIG. 3 is adjusted by means of the valve 60. The heat exchanger 62 is a component of the tank system 16 and is explained again in more detail in the following. If, for example, the valve 60 is completely opened, this enables a maximum heat flow into the hydrogen tank 14. If the valve 60 is closed, the hydrogen tank 14 is, for example, not heated (any longer), which can be the case in particular for a partial load, whereby, for example, the tank pressure sinks (again).

Compared to conventional solutions, the energy consumption of the fuel cell system 10 can be reduced by the method, whereby an energy consumption of the entire motor vehicle 12 can be kept particularly low. Therefore, the motor vehicle 12 can be operated in a particularly cost-effective manner. Furthermore, overloading the cooling device 30 with associated shutdowns of components, such as for example, the drive device can be delayed or completely avoided.

The cooling device 30 has, for example, a cooling circuit 64 that the coolant can flow through, of which conduit elements 66 and 68 are shown in part in FIG. 3. The conduit elements 66 and 68 can be flowed through by the coolant. By means of the conduit element 66, the coolant containing heat in particular, such as the second part of the total waste heat, can be supplied to the heat exchanger 62. For example, a valve 70 arranged in the conduit element 66 can be used to adjust a flow of the coolant through the conduit element 66 and, in particular, towards the heat exchanger 62. The valve 70 can be controlled by the thermal management module 42, so that the thermal management module 42 can adjust, in particular control or regulate the flow of the coolant through the conduit element 66 to the heat exchanger 62 via the valve 70. The coolant can be discharged from the heat exchanger 62 via the conduit element 68.

The hydrogen tank 14 can be ventilated via a vent line 72, and the hydrogen tank 14 can be refueled via a tank device 74. Blow-off lines are referenced with 76, a valve designed, for example, as a tank valve is referenced with 78, and a valve formed for example, as a safety valve is referenced with 80. For example, the hydrogen can be discharged from the hydrogen tank 14 via a conduit element 82 and in particular supplied to the fuel cell 18. It can be seen that the operating module 56, for example, can control and thus operate the valve 78 and the valve 60, and for example the operating module 56 can control and thus operate the heat exchanger 62. The aforementioned temperature sensors are referenced in FIG. 3 with 84, and the aforementioned pressure sensors are referenced with 86. A amount of hydrogen received (again) in the hydrogen tank 14 can be detected by means of a detecting means 88, wherein the amount of hydrogen received in the hydrogen tank 14 is referred to as a fill level. The detecting means 88 can provide at least one, in particular electrical, signal characterizing the fill level, which can be received by the operating module 56. The operating module 56 can report back the detected temperatures, the detected pressures and the detected fill level to the operating strategy module 38, which subsequently can create the requirements and can specify them to the operating module 56, so that for example the tank system 16 can be operated, in particular controlled or regulated, by means of the thermal management module 42 and by means of the operating module 56, in particular depending on the detected temperatures and depending on the detected pressures and depending on the detected fill level, in particular in such a way that the target trajectories are actually implemented, i.e., realized.

It can be seen from FIG. 3 that the heat contained in the coolant and thus the aforementioned second part of the total waste heat can be transmitted to the hydrogen tank 14, in particular to the hydrogen in the hydrogen tank 14, via the heat exchanger 62, in order therefore to warm up, i.e., heat, the hydrogen tank 14 and thus the hydrogen received in the hydrogen tank 14. Therefore, the hydrogen tank 14 can be used at least temporarily as a heat buffer, whereby the energy consumption of the cooling device 30 can be kept advantageously low. Furthermore, for example, the heat contained in the coolant, i.e., the second part of the total waste heat, can be transmitted to the hydrogen flowing through the conduit element 82, in particular in the gaseous state, via the heat exchanger 62, which hydrogen for example is discharged from the hydrogen tank 14 by means of the conduit element 82 and supplied to the fuel cell 18. As a result, the in particular gaseous hydrogen, which is supplied to the fuel cell 18, can be heated, in particular preheated, on its way to the fuel cell 18, so that the second part of the waste heat can be advantageously discharged, in particular without having to operate the aforementioned fan.

### LIST OF REFERENCE SIGNS

10 fuel cell system
12 motor vehicle
14 hydrogen tank
16 tank system
18 fuel cell
20 arrow
22 arrow
24 arrow
26 arrow
28 sustained-action brake
30 cooling device
32 heating device
34 arrow
35 planning module
36 arrow
38 operating strategy module
40 arrow
42 thermal management module
44 arrow
46 actuator
48 sensor
50 arrow
52 arrow
54 arrow
56 operating module
58 arrow
60 valve
62 heat exchanger
64 cooling circuit
66 conduit element
68 conduit element
70 valve
72 vent line
74 tank device
76 blow-off line
78 valve
80 valve
82 conduit element
84 temperature sensor
86 pressure sensor
88 detecting means

1-6. (canceled)

7. A method for operating a fuel cell system of a motor vehicle, wherein the fuel cell system comprises a hydrogen tank, a fuel cell suppliable with hydrogen from the hydrogen tank, and a cooling device configured to cool at least one part of the fuel cell system, the method comprising:
predicting energy consumption of the cooling device depending on a planned driving route of the motor vehicle;
predicting a future temporal pressure curve of a pressure prevailing in the hydrogen tank; and
predicting a future temporal energy curve of an amount of heat energy to be supplied according to the future temporal energy curve from the cooling device to the hydrogen tank depending on the predicted energy consumption of the cooling device to achieve the future temporal pressure curve.

8. The method of claim 7, wherein the future temporal pressure curve and the future temporal energy curve are predicted in such a way that in first operating phases of the cooling device, in which first operating phases energy consumption is greater than in second operating phases of the cooling device, greater thermal energy is supplied from the cooling device to the hydrogen tank than in second operating phases.

9. The method of claim 8, wherein, in at least one of the second operating phases, a transfer of thermal energy from the cooling device to the hydrogen tank does not occur.

10. The method of claim 7, wherein the future temporal pressure curve is predicted in such a way that the pressure is always less than or equal to a maximum pressure over an entirety of the pressure curve.

11. The method of claim 7, wherein at least the future temporal pressure curve is predicted depending on at least one refueling process provided to fill the hydrogen tank or depending on at least one standstill time of the motor vehicle.

12. The method of claim 7, wherein, during operation of the motor vehicle, the method further comprises:
controlling a supply of heat from the cooling device to the hydrogen tank based on the predicted future temporal energy curve and the predicted future temporal pressure curve.

13. A motor vehicle comprising:
a fuel cell system, which comprises a hydrogen tank, a fuel cell suppliable with hydrogen from the hydrogen tank, and a cooling device configured to cool at least one part of the fuel cell system,
wherein the motor vehicle is configured to
predict energy consumption of the cooling device depending on a planned driving route of the motor vehicle;
predict a future temporal pressure curve of a pressure prevailing in the hydrogen tank; and
predict a future temporal energy curve of an amount of heat energy to be supplied according to the future temporal energy curve from the cooling device to the hydrogen tank depending on the predicted energy consumption of the cooling device to achieve the future temporal pressure curve.
